(19) United States
(12) Patent Application Publication
(10) Pub. No.: US 2016/0012286 A1
(43) Pub. Date: Jan. 14, 2016

(54) ELECTRONIC APPARATUS, METHOD AND STORAGE MEDIUM

(71) Applicant: Kabushiki Kaisha Toshiba, Tokyo (JP)

(72) Inventor: Chikashi Sugiura, Hamura Tokyo (JP)

(21) Appl. No.: 14/633,853

(22) Filed: Feb. 27, 2015

(30) Foreign Application Priority Data
Jul. 9, 2014 (JP) 2014-141356

(51) Int. Cl. G06K 9/00; G06K 9/46

(52) U.S. Cl. CPC G06K 9/00422; G06K 9/46; G06K 9/4642; G06K 2009/4666

(57) ABSTRACT

According to one embodiment, an electronic apparatus includes a circuitry. The circuitry is configured to input data of an image including a plurality of ruled lines separated by intervals and a plurality of characters. The circuitry is configured to detect a first pair and a second pair of reference ruled lines out of the ruled lines. The circuitry is configured to execute a process for determining the handwritten characters falling within the gap between the first pair of reference ruled lines as one structure, when the characters included in the image fall within a gap between the first pair of reference ruled lines.

### CROSS-REFERENCE TO RELATED APPLICATIONS

This application is based upon and claims the benefit of priority from Japanese Patent Application No. 2014-141356, filed Jul. 9, 2014, the entire contents of which are incorporated herein by reference.

### FIELD

Embodiments described herein relate generally to an electronic apparatus, a method and a storage medium.

### BACKGROUND

A common method is inconvenient in respect that a character string part cannot be extracted from an image including handwritten characters with high accuracy. For this reason, realization of a new technique is desired for extracting a character string part from an image including handwritten characters with high accuracy.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an external appearance of an electronic apparatus according to an embodiment.

FIG. 2 illustrates a system configuration of a tablet computer.

FIG. 3 is illustrated for explaining a common process for detecting a string structure from a handwritten character image.

FIG. 4 is illustrated for explaining a common process for detecting a string structure from a handwritten character image.

FIG. 5 is a block diagram illustrating an example of a function configuration of a string structure detection application program according to the embodiment.

FIG. 6 is illustrated for explaining a method for detecting a ruled line by a ruled line detector according to the embodiment.

FIG. 7 is illustrated for explaining a method for detecting a ruled line by the ruled line detector according to the embodiment.

FIG. 8 is illustrated for explaining a method for detecting a barycenter by a barycenter detector according to the embodiment.

FIG. 9 is illustrated for explaining a method for determining a reference ruled line by a character-described-position determination module according to the embodiment.

FIG. 10 is illustrated for explaining a method for determining a reference ruled line by the character-described-position determination module according to the embodiment.

FIG. 11 is illustrated for explaining correction of an image by the string structure detection application program according to the embodiment.

FIG. 12 is a flowchart illustrating examples of steps of a process executed by the string structure detection application program according to the embodiment.

### DETAILED DESCRIPTION

Various embodiments will be described hereinafter with reference to the accompanying drawings.

In general, according to one embodiment, an electronic apparatus includes a circuitry. The circuitry is configured to input data of an image including a plurality of ruled lines separated by intervals and a plurality of characters. The circuitry is configured to detect a first pair and a second pair of reference ruled lines out of the ruled lines. The circuitry is configured to execute a process for determining the handwritten characters falling within the gap between the first pair of reference ruled lines as one structure, when the characters included in the image fall within a gap between the first pair of reference ruled lines. The circuitry is configured to execute a process for determining a first part of the characters as one structure and a second part of the characters as one structure, when the first part of the plurality of the characters included in the image fall within a gap between the first pair of reference ruled lines and the second part of the plurality of the characters included in the image goes beyond the first pair of reference ruled lines and fall within a gap between the second pair of reference ruled lines.

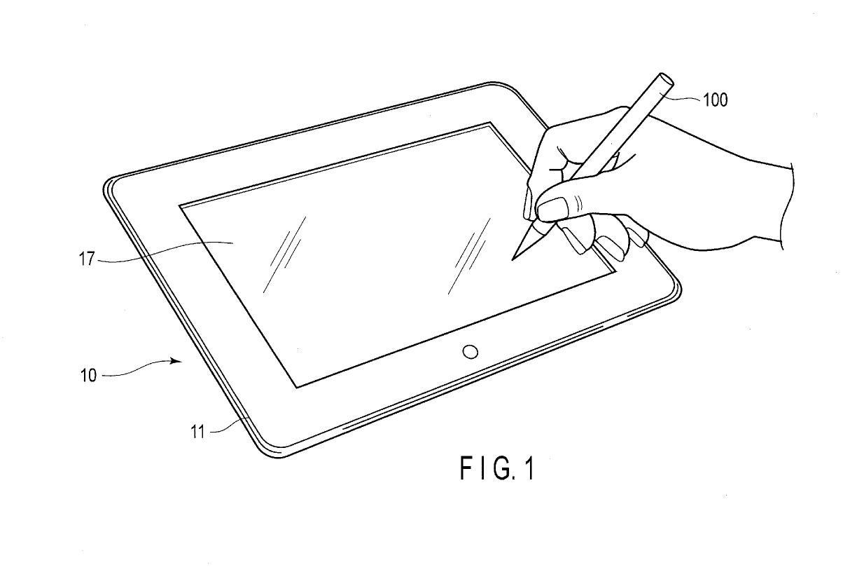

FIG. 1 is a perspective view illustrating an external appearance of an electronic apparatus according to an embodiment. The electronic apparatus is, for example, a stylus-based portable electronic apparatus which enables handwritten input by a stylus or a finger. The electronic apparatus can be realized as a tablet computer, a notebook computer, a smartphone, a PDA and the like. Hereinafter, the electronic apparatus is assumed to be realized as a tablet computer 10. The tablet computer 10 is a portable electronic apparatus which is also referred to as a tablet or a slate computer. As shown in FIG. 1, the tablet computer 10 includes a main body 11 and a touchscreen display 17. The touchscreen display 17 is attached to an upper surface of the main body 11 such that the touchscreen display 17 overlaps with the upper surface of the main body 11. The touchscreen display 17 may be, for example, a liquid crystal display (LCD) device.

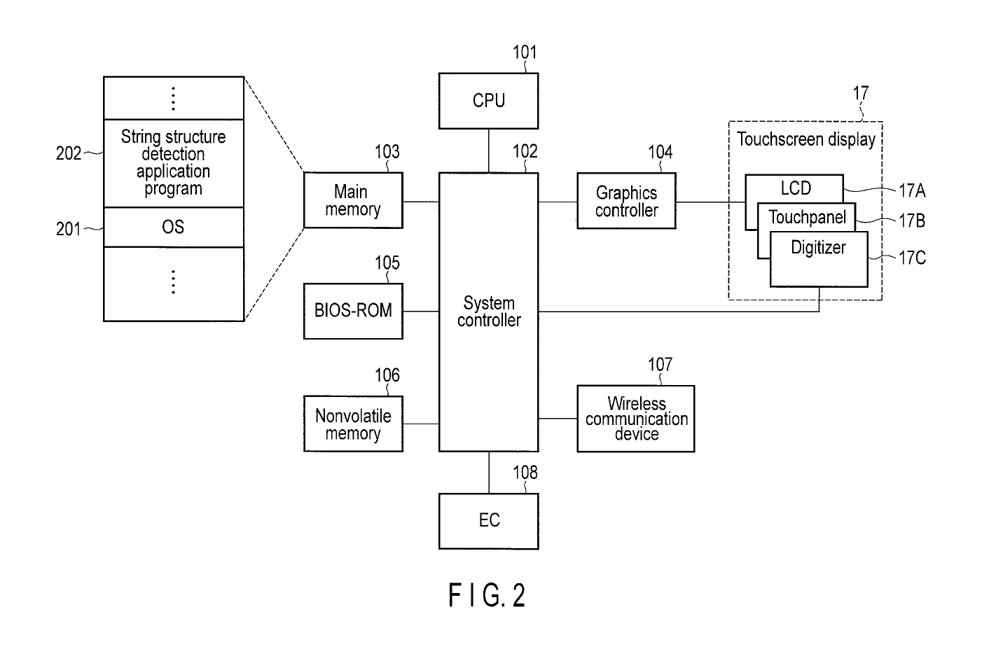

FIG. 2 illustrates a system configuration of the tablet computer 10.

As shown in FIG. 2, the tablet computer 10 includes a CPU 101, a system controller 102, a main memory 103, a graphics controller 104, a BIOS-ROM 105, a nonvolatile memory 106, a wireless communication device 107, an embedded controller (EC) 108 and the like.

The CPU 101 is a processor to control operations of various modules of the tablet computer 10. The CPU 101 executes various types of software loaded from the nonvolatile memory 106 which is a storage device to the main memory 103. The software includes an operating system (OS) 201 and various application programs. The application programs include a string structure detection application program 202. The string structure detection application program 202 has a function for detecting one or more than one string structure from data of an image including handwritten characters. Specifically, the string structure detection application program 202 has a function for detecting one or more than one string structure from data of an image (hereinafter, referred to as a “handwritten character image”) including a plurality of ruled lines having a first distance and a plurality of handwritten characters described along the plurality of ruled lines.

The CPU 101 also executes a basic input/output system (BIOS) stored in the BIOS-ROM 105. The BIOS is a program for hardware control.

The system controller 102 is a device configured to connect a local bus of the CPU 101 and various components. The system controller 102 includes a built-in memory controller to control the access of the main memory 103. The system controller 102 has a function for performing communication with the graphics controller 104 via a serial bus compatible with PCI EXPRESS standards, etc.

The graphic controller 104 is a display controller to control an LCD 17A used as a display monitor of the tablet computer 10. A display signal produced by the graphic controller 104 is transmitted to the LCD 17A. The LCD 17A displays a screen image based on the display signal. A touchpanel 17B, the LCD 17A and a digitizer 17C overlap with each other. The touchpanel 17B is a capacitive pointing device for inputting data on the screen of the LCD 17A. The touchpanel 17B detects the contact position of a finger on the screen, movement of the position and the like. The digitizer 17C is an electromagnetic-induction-type pointing device for inputting data on the screen of the LCD 17A. The digitizer 17C detects the contact position of a stylus (digitizer stylus) 100 on the screen, movement of the position and the like.

The wireless communication device 107 is a device to perform wireless communication by using a wireless LAN or 3G mobile communication, etc. The EC 108 is a one-chip microcomputer including an embedded controller for power management. The EC 108 has a function for switching on or off the tablet computer 10 in accordance with the operation of a power button by the user.

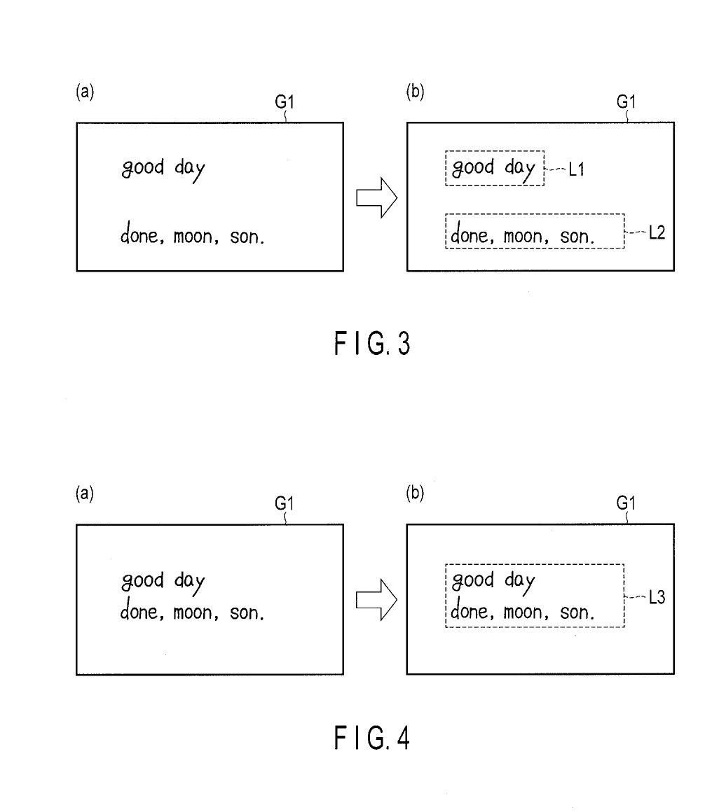

Now, this specification explains a common process for detecting a string structure from a handwritten character image, referring to FIG. 3 and FIG. 4.

Each of FIG. 3 and FIG. 4 is illustrated for explaining a common process for detecting a string structure from a handwritten character image. As shown in FIG. 3(a), a handwritten character image G1 does not include (describe) a ruled line for indicating a line space. However, a large gap is provided between a group of handwritten characters “good day” and a group of handwritten characters “done, moon, son.” In this case, a pseudo-line consisting of a certain number of continuous white pixels or greater is regarded as a line separating the above-described two groups of handwritten characters. In this way, as shown in FIG. 3(b), it is possible to easily detect string structure L1 including the group of handwritten characters “good day” and string structure L2 including the group of handwritten characters “done, moon, son.”

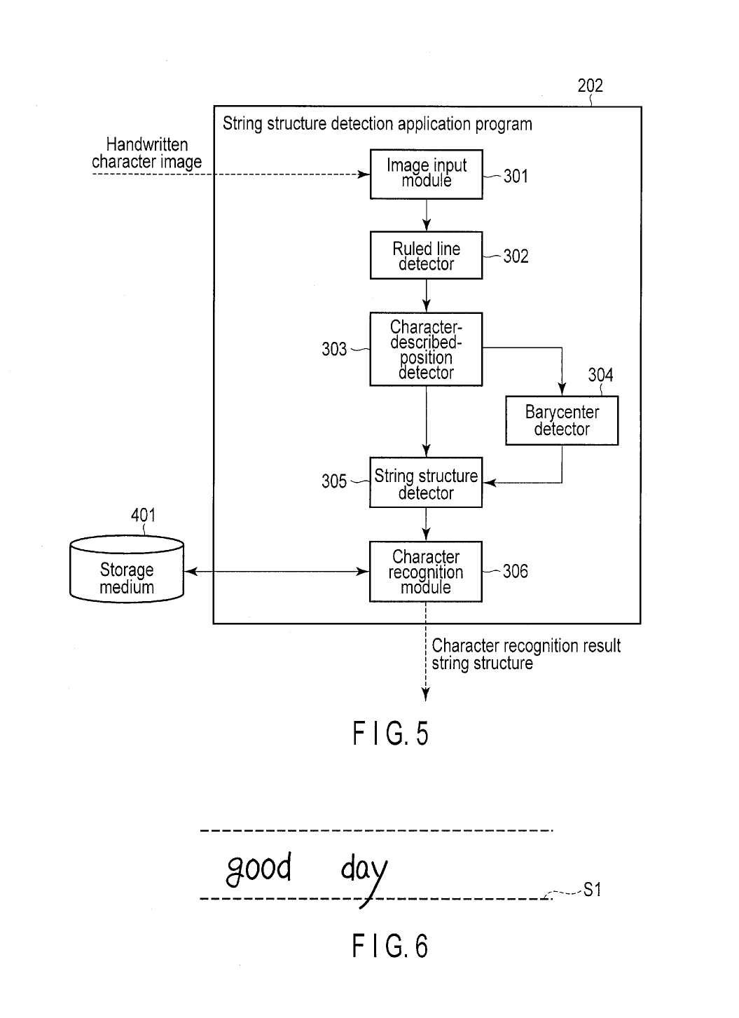

However, in a case where the gap between two groups of handwritten characters is narrow as shown in FIG. 4(a), the two groups of handwritten characters may be detected as, as shown in FIG. 4(b), one string structure (L3) in a common process for detecting a string structure (in other words, the first and second strings may be detected as a connected string). Thus, false detection may occur. In consideration of this factor, in the present embodiment, the string structure detection application program 202 has a function for reducing the possibility that the above-described false detection occurs. The function configuration of the string structure detection application program 202 is explained below with reference to FIG. 5.

FIG. 5 is a block diagram illustrating an example of the function configuration of the string structure detection application program 202. As shown in FIG. 5, the string structure detection application program 202 includes an image input module 301, a ruled line detector 302, a character-described-position determination module 303, a barycenter detector 304, a string structure detector 305, a character recognition module 306 and the like.

The image input module 301 has a function for receiving the input of a handwritten character image. In the present embodiment, a handwritten character image is, as stated above, data of an image including ruled lines having a first distance and handwritten characters described along the ruled lines. However, instead of ruled lines, for example, grid lines or staff notations may be included in a handwritten character image. A handwritten character image may be an image taken by the camera function of the tablet computer 10, or an image taken by a photographing device other than the tablet computer 10. An input handwritten character image is transmitted to the ruled line detector 302.

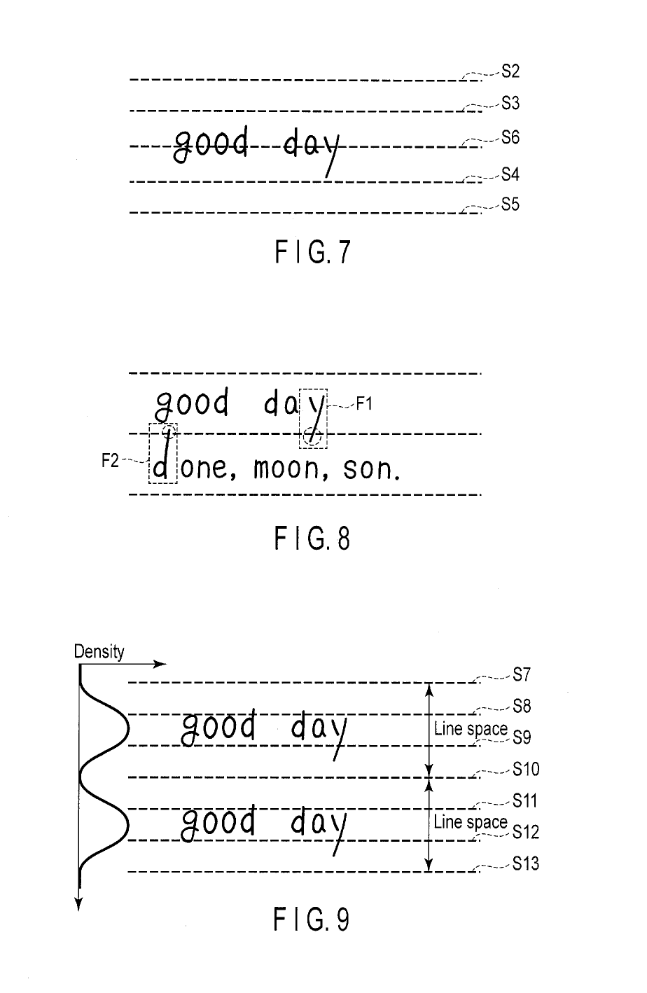

The ruled line detector 302 has a function for detecting a plurality of ruled lines included in the handwritten character image transmitted from the image input module 301. For example, ruled lines may be detected by using Hough transformation. In this detection method, ruled lines (straight lines) in a handwritten character image are detected by binarizing the image and applying Radon transformation to the binarized image. As another method for detecting ruled lines, for example, if the color of ruled lines is identified in advance, the number of pixels having the color of ruled lines is counted. If a certain number of pixels having the color of ruled lines or greater are continuous, these pixels are detected as ruled lines. When this detection method is employed, it is necessary to take into account a case where a handwritten character is described on a ruled line as shown in FIG. 6 and a part of the ruled line is divided. In consideration of such a case, if straight lines detected as ruled lines exist before and after a divided part, the ruled lines need to be detected as being continuous over the divided part. In this way, it is possible to detect straight line S1 of FIG. 6 as one ruled line. When ruled lines are detected by using the detection method of counting the number of pixels having the color of ruled lines, it is necessary to take into account a case where handwritten characters are described in a large part of a ruled line as shown in FIG. 7. In consideration of this case, if the distance between straight line S3 and straight line S4 is largely different from the distance between the other straight lines (S2-S3, S4-S5), ruled lines need to be detected such that a ruled line hidden by handwritten characters exists between straight line S3 and straight line S4. In this manner, straight line S6 of FIG. 7 can be detected as a ruled line.

The handwritten-character-described position determination module 303 has a function for determining whether or not a handwritten character in a handwritten character image falls within the gap (the line space) between two reference ruled lines, which are fundamental ruled lines out of the plurality of ruled lines detected by the ruled line detector 302. Specifically, the handwritten-character-described position determination module 303 determines whether or not the coordinate of each of the pixels constituting the handwritten character in the handwritten image includes the coordinates of the detected reference ruled lines in order to determine whether or not the handwritten character falls within the gap between the reference ruled lines. When the handwritten character is detected as falling within the gap between the reference ruled lines, a string structure detection process is executed as explained later. On the other hand, when the handwritten character is detected as going beyond the gap between the reference ruled lines, a barycenter detection process is executed as described later.

Based on the shape of the handwritten character determined as going beyond the gap between the reference ruled lines by the handwritten-character-described position determination module 303, the barycenter detector 304 executes a process for specifying between which reference ruled lines the handwritten character is described. Specifically, the barycenter detector 304 firstly executes a barycenter detection process, which detects the barycenter of the handwritten character determined as going beyond the gap between the reference ruled lines. As a method for detecting a barycenter, for example, as shown in FIG. 8, handwritten characters “y” and “d”, which are determined as going beyond the gap between the reference ruled lines (in other words, handwritten characters to which the barycenter detection process should be applied), are surrounded by rectangular frames F1 and F2, and the barycenter of each of rectangular frames F1 and F2 is calculated. In this manner, the barycenter of each of the handwritten characters to which the barycenter detection process should be applied is detected. As another method for detecting a barycenter, the barycenter of a handwritten character to which the barycenter detection process should be applied is detected by calculating the average coordinate of pixels constituting the handwritten character. When the barycenter detector 304 detects the barycenter of the handwritten character to which the barycenter detection process should be applied, the barycenter detector 304 regards the handwritten character as falling within (or belonging to) the gap between the reference ruled lines in which the detected barycenter is located.

The string structure detector 305 executes a string structure detection process, which detects one or more than one string structure from a handwritten character image. Specifically, the string structure detector 305 detects one or more than one handwritten character falling within the same gap between reference ruled lines as one string structure.

The character recognition module 306 has a function for applying optical character recognition (OCR) to handwritten characters included in one or more than one string structure detected by the string structure detector 305. In other words, the character recognition module 306 executes a process for obtaining a character recognition result relative to one or more than one handwritten character included in one or more than one string structure which has been detected. The OCR refers to conversion of a handwritten character image into a form (character code columns) editable in the computer 10.

The result of optical character recognition by the character recognition module 306 is arbitrarily stored in a storage medium 401. In the storage medium 401, for example, as a result of optical character recognition, identification information for identifying the string structures to which the optical character recognition has been applied, and character code columns of handwritten characters included in the string structures are stored in association with each other.

Now, this specification explains a method for determining reference ruled lines, referring to FIG. 9. Reference ruled lines are determined by the character-described-position determination module 303. Specifically, the character-described-position determination module 303 firstly calculates density indicating how densely handwritten lines are described for each ruled line detected by the ruled line detector 302. After the density is calculated, the character-described-position determination module 303 generates a histogram related to the calculated density as shown in FIG. 9. After that, the character-described-position determination module 303 determines ruled lines S7, S10 and S13, which have low density in the histogram shown in FIG. 9, as reference ruled lines. At this time, a first pair and a second pair reference ruled lines may determine. Herewith, the string structure detector 305 executes a process for determining the handwritten characters falling within the gap between the first pair of reference ruled lines as one structure, when the characters included in the image fall within a gap between the first pair of reference ruled lines. Also, the string structure detector 305 executes a process for determining a first part of the characters as one structure and a second part of the characters as one structure, when the first part of the plurality of the characters included in the image fall within a gap between the first pair of reference ruled lines and the second part of the plurality of the characters included in the image goes beyond the first pair of reference ruled lines and fall within a gap between the second pair of reference ruled lines. The method for determining reference ruled lines is not limited to the above-described method.

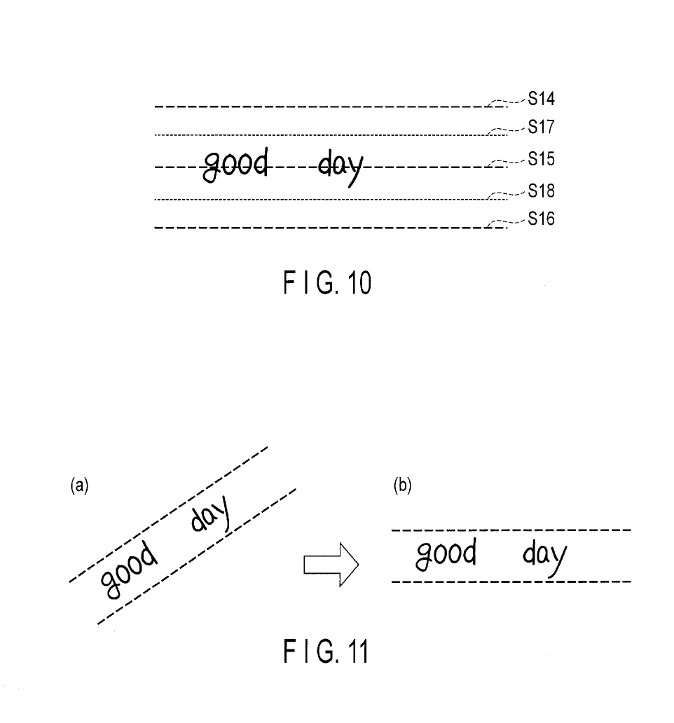

For example, the character-described-position determination module 303 may determine reference ruled lines in line with the language of handwritten characters in a handwritten character image. For example, as shown in FIG. 10, sometimes alphabets are written such that the center of each character is positioned on a ruled line. In this case, if the above-described process for detecting a string structure is executed by using the reference ruled lines determined by the above-described method for determining reference ruled lines, a string structure may not be accurately detected. For this reason, if the handwritten characters included in the handwritten character image are alphabets, instead of determining some of the ruled lines detected by the ruled line detector 302 as reference ruled lines, the character-described-position-determination module 303 may draw pseudo-ruled lines S17 and S18 between the ruled lines detected by the ruled line detector 302 as shown in FIG. 10, determine pseudo-ruled lines S17 and S18 as reference ruled lines, and execute the above-described process for detecting a string structure. Thus, it is possible to execute processes in accordance with a wide variety of languages by providing adjustment items related to reference ruled lines based on the language of handwritten characters in a handwritten character image (for example, as stated above, if the handwritten characters are alphabets, pseudo-ruled lines may be drawn and be determined as reference ruled lines).

Further, the string structure detection application program 202 may execute the above-described process for detecting a string structure after correcting the input handwritten character image in accordance with the direction of ruled lines. For example, if the handwritten characters in the input handwritten character image obliquely incline as shown in FIG. 11(a), the string structure detection application program 202 may execute the above-described process for detecting a string structure after correcting the input handwritten character image such that the handwritten characters in the handwritten character image are laterally arranged in line as shown in FIG. 11(b).

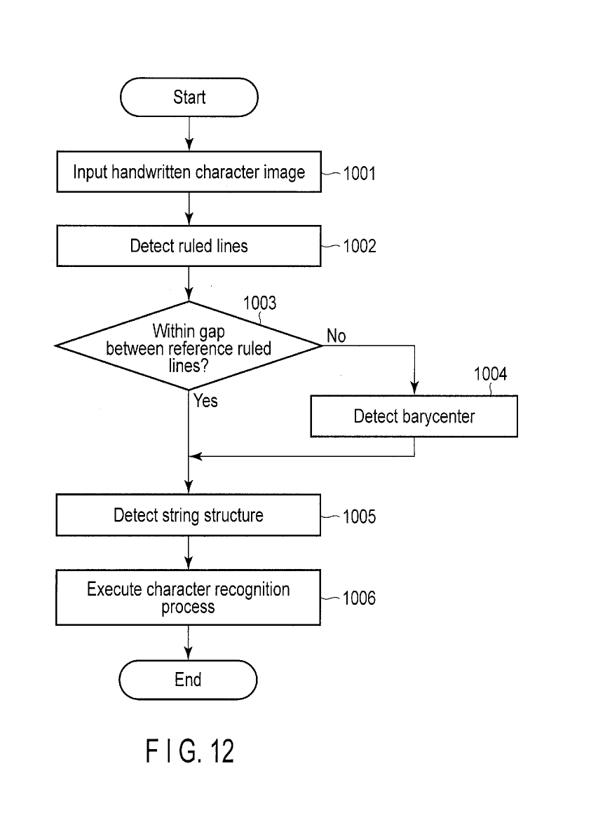

Now, this specification explains examples of steps of a process executed by the string structure detection application program 202 with reference to the flowchart shown in FIG. 12.

First, the image input module 301 receives the input of a handwritten character image (block 1001). Next, the ruled line detector 302 detects a plurality of ruled lines included in the input handwritten character image (block 1002).

After that, the character-described-position detection module 303 determines whether or not the handwritten characters in the input handwritten character image fall within the gap between two adjacent reference ruled lines (out of a plurality of reference ruled lines) out of the plurality of ruled lines detected by the ruled line detector 302 (block 1003).

When the handwritten characters are determined as going beyond the gap between the two adjacent reference ruled lines (NO in block 1003), the barycenter detector 304 detects the barycenter of the handwritten character which goes beyond the gap between two adjacent reference ruled lines, and specifies between which two reference ruled lines the detected barycenter falls (in other words, specifies to between which two reference ruled lines the detected barycenter belongs) (block 1004). Hereby, the string structure detection application program 202 determines that the handwritten characters describe (or fall within a gap) between the specified reference ruled lines. After the step of block 1004 ends, the process proceeds to the step of block 1005 explained below.

When the handwritten characters are detected as falling within the gap between the two adjacent reference ruled lines (or the gap between the specified reference ruled lines) (YES in block 1003), the string structure detector 305 detects the handwritten characters falling within the gap between the two adjacent ruled lines (or the gap between the specified reference ruled lines) as one string structure (block 1005).

After that, the character recognition module 306 applies optical character recognition to the handwritten characters included in the string structure detected by the string structure detector 305 (block 1006), and terminates the process.

In the embodiment explained above, a string structure can be detected from a handwritten character image by using a background image such as ruled lines in the handwritten character image. Therefore, a character string part in the handwritten character image can be extracted with high accuracy. With this configuration, for example, by merely touching a predetermined handwritten character in a handwritten character image, the user of the tablet computer 10 can select a character string part including the predetermined handwritten characters. Thus, convenience can be largely improved.

The processes of the present embodiment can be realized by a computer program. Therefore, by merely installing the computer program into a computer through a computer readable storage medium in which the computer program is stored, and executing the computer program, an effect similar to the present embodiment can be easily obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
circuitry configured to:
input data of an image including a plurality of ruled lines separated by intervals and a plurality of characters;
detect a first pair and a second pair of reference ruled lines out of the ruled lines;
execute a process for determining the handwritten characters falling within the gap between the first pair of reference ruled lines as one structure, when the characters included in the image fall within a gap between the first pair of reference ruled lines; and
execute a process for determining a first part of the characters as one structure and a second part of the characters as one structure, when the first part of the plurality of the characters included in the image fall within a gap between the first pair of reference ruled lines and the second part of the plurality of the characters included in the image goes beyond the first pair of reference ruled lines and fall within a gap between the second pair of reference ruled lines.

2. The electronic apparatus of claim 1, wherein
the circuitry is configured to execute a process for obtaining a character recognition result of the handwritten characters in the structure.

3. The electronic apparatus of claim 1, wherein
the circuitry is further configured to determine the first pair and the second pair of reference ruled lines based on which ruled line has more density in a histogram of the image of the handwritten characters along the ruled lines.

4. The electronic apparatus of claim 1, wherein
the reference ruled lines are based on a language of one or more handwritten characters included in the image.

5. The electronic apparatus of claim 1, wherein
the circuitry is further configured to correct the image in accordance with a direction of one or more ruled lines included in the image.

6. A method comprising:
inputting data of an image including a plurality of ruled lines separated by intervals and a plurality of characters;
detecting a first pair and a second pair of reference ruled lines out of the ruled lines;
executing a first process for determining the handwritten characters falling within the gap between the first pair of reference ruled lines as one structure, when the characters included in the image fall within a gap between the first pair of reference ruled lines; and
executing a second process for determining a first part of the characters as one structure and a second part of the characters as one structure, when the first part of the plurality of the characters included in the image fall within a gap between the first pair of reference ruled lines and the second part of the plurality of the characters included in the image goes beyond the first pair of reference ruled lines and fall within a gap between the second pair of reference ruled lines.

7. The method of claim 6, wherein
the first process and the second process further obtains a character recognition result of the handwritten characters included in the structure.

8. The method of claim 6, wherein
the detecting further determines the first pair and the second pair of reference ruled lines based on which ruled line has more density in a histogram of the image of the handwritten characters along the ruled lines.

9. The method of claim 6, wherein
the reference ruled lines are based on a language of one or more handwritten characters included in the image.

10. The method of claim 6, wherein
the first process and the second process corrects the image in accordance with a direction of one ore more ruled lines included in the image.

11. A non-transitory computer-readable medium storing computer-executable instructions that, when executed, cause a computer to perform:
inputting data of an image including a plurality of ruled lines separated by intervals and a plurality of characters;
detecting a first pair and a second pair of reference ruled lines out of the ruled lines;
executing a first process for determining the handwritten characters falling within the gap between the first pair of reference ruled lines as one structure, when the characters included in the image fall within a gap between the first pair of reference ruled lines; and
executing a second process for determining a first part of the characters as one structure and a second part of the characters as one structure, when the first part of the plurality of the characters included in the image fall within a gap between the first pair of reference ruled lines and the second part of the plurality of the characters included in the image goes beyond the first pair of reference ruled lines and fall within a gap between the second pair of reference ruled lines.

12. The computer-readable medium of claim 11, wherein the first process and the second process further obtains a character recognition result of the handwritten characters included in the structure.

13. The computer-readable medium of claim 11, wherein the detecting further determines the first pair and the second pair of reference ruled lines based on which ruled line has more density in a histogram of the image of the handwritten characters along the ruled lines.

14. The computer-readable medium of claim 11, wherein the reference ruled lines are based on a language of one or more handwritten characters included in the image.

15. The computer-readable medium of claim 11, wherein the first process and the second process corrects the image in accordance with a direction of one ore more ruled lines included in the image.
